(19) United States
(12) Patent Application Publication
(10) Pub. No.: US 2017/0153467 A1
(43) Pub. Date: Jun. 1, 2017

(54) WIRELESS CONTROLLING POLYMER DISPERSED LIQUID CRYSTAL SMART WINDOW

(71) Applicant: NANOBIT TECH. CO., LTD., Taoyuan City (TW)

(72) Inventors: Yu-Yang CHANG, Taoyuan City (TW); Shiou-Ming LIU, Taoyuan City (TW); Te-Liang YU, Taoyuan City (TW); Fu-Tien KU, Taoyuan City (TW); Ding-Kuo DING, Taoyuan City (TW)

(21) Appl. No.: 15/248,459

(22) Filed: Aug. 26, 2016

(30) Foreign Application Priority Data
Nov. 27, 2015 (TW) 104219071

(51) Int. Cl. G02F 1/137; E06B 9/24; G02F 1/133; G02F 1/1334; G02F 1/1333

(52) U.S. Cl. CPC G02F 1/137; G02F 1/1334; G02F 1/133305; G02F 1/13306; E06B 9/24; E06B 2009/247

(57) ABSTRACT

A wireless controlling PDLC smart window is provided. The smart window comprises a composite layer, a control device, a wireless receiver unit and a wireless emitter unit. The control device is connected electrically with the composite layer. The wireless receiver unit is connected electrically with the control device. The wireless emitter unit is coupled to the wireless receiver unit. The wireless emitter unit may emit a message of control operation to the wireless receiver unit. The message is transmitted from the wireless receiver unit to the control device. The control device may drive the composite layer to display information or pattern after the massage is processed.

### BACKGROUND OF THE INVENTION

Field of the Invention

The present invention relates to a smart window, more particularly to a smart window which can produce the effect of changeable light transmission and combines with wireless control.

Description of the Related Art

A traditional polymer dispersed liquid crystal (PDLC) is formed by using anisotropic liquid crystal droplets distributing in polymers uniformly, typically anisotropic liquid crystal droplets with positive dielectric constant distributing in polymers uniformly that have no a specific direction in a normal state, and the light transmitted through the anisotropic liquid crystal droplets fails to match with the refractive index of the polymers so that incident light may scatter seriously due to many interfaces existing and light transmission rate is low. If a specific electric field is provided, the anisotropic liquid crystal droplets with positive dielectric constant may be arranged forward along the electric field, and the light transmitted through the anisotropic liquid crystal droplets with positive dielectric constant may match with the refractive index of the polymers so that the most incident light may transmit through forward and the light transmission rate is increased. Smart windows are formed by packaging PDLC in transparent substrates such as conductive glasses and switching the electric field on or off to control the change of transparency of the transparent substrates. Smart windows can dynamically change the tinting of glass to control the amount of light/heat that enters a building. They can also be used to create on-demand private spaces for offices. Recently, soft conductive transparent resins have been used to package PDLC instead of the conductive glasses by the advancing process and material so that the process can be simplified greatly and the application of the related products can be enhanced greatly. For example, the structure of soft conductive transparent resins packaging PDLC in combination with transparent adhesive technologies can be attached on glass of buildings, windows of cars, refrigerators or projection walls for increasing use of applications.

To take advantage of circuit design of the transparent conductive layer, smart Windows can perform for controlling light transmission of local region, and thus transmission control mechanisms can be improved to increase the operation convenience.

### SUMMARY OF THE INVENTION

It is an object of the present invention to disclose a wireless controlling polymer dispersed liquid crystal smart window (hereinafter referred to as wireless controlling PDLC smart window). The wireless controlling PDLC smart window comprises a composite layer with controllable local light transmission, a control device, a wireless receiver unit and a wireless emitter unit. The wireless controlling PDLC smart window can produce the effect of changeable light transmission by wireless controlling. It is convenient for users to operate the smart window by remote control.

It is another object of the present invention to disclose a wireless controlling polymer dispersed liquid crystal smart window which has a light transmission structure, wherein the above-mentioned composite layer is adhered with two light transmission elements, for example resin sheet or glass.

The object described above is achieved by providing a wireless controlling PDLC smart window, wherein the smart window comprises a composite layer, a control device, a wireless receiver unit and a wireless emitter unit. The control device is connected electrically with the composite layer. The wireless receiver unit is connected electrically with the control device. The wireless emitter unit is coupled to the wireless receiver unit. The wireless emitter unit may emit a message of control operation to the wireless receiver unit. The message is transmitted from the wireless receiver unit to the control device. The control device may drive the composite layer to display information or pattern after the massage is processed.

In an aspect of the invention, the composite layer comprises a first soft resin sheet, a first transparent conductive layer, a second soft resin sheet, a second transparent conductive layer and a first PDLC layer. The first soft resin sheet has a first curing layer on a side surface thereof. The first transparent conductive layer is provided on a side surface of the first curing layer, and electrically connected with the control device, the first transparent conductive layer comprising a first circuit region and a first cable region. The second soft resin sheet has a second curing layer on a side surface of thereof. The second transparent conductive layer is provided on a side surface of the second curing layer, and electrically connected with the control device, the second transparent conductive layer comprising a second circuit region and a second cable region. The first polymer dispersed liquid crystal (PDLC) layer is provided between the first transparent conductive layer and the second transparent conductive layer.

In an aspect of the invention, the first soft resin sheet and the second soft resin sheet are a material of light transmission resin. The light transmission resin is polyethylene terephthalate (PET), polyethylene (PE), polyimide (PI), polyamide (PA), polyurethanes (PU) or acrylic resin. The first soft resin sheet has a thickness in a range of 10 um-500 um and the second soft resin sheet has a thickness in a range of 10 um-500 um. The first curing layer or the second curing layer is a material selected from the group consisting of acrylic resin, epoxy and silica. The first curing layer or the second curing layer has a thickness in a range of 1 um-5 um.

In an aspect of the invention, the first transparent conductive layer and the second transparent conductive layer are made of an inorganic conductive material or an organic conductive material, wherein the inorganic conductive material is a material of metal or metallic oxide, and the organic conductive material is a conductive material mixing with carbon nanotube or poly-3,4-ethylenedioxythiophene. The first transparent conductive layer or the second transparent conductive layer has a thickness in a range of 5 nm-50 um. The first transparent conductive layer or the second transparent conductive layer has a thickness in a range of 100 nm-10 um. The first transparent conductive layer or the second transparent conductive layer has the light transmission rate of 70%-95%.

In an aspect of the invention, the first PDLC layer is formed of PDLC resins as a main element and mixing with a material selected from the group consisting of UV resins, thermal setting resins and silica. The first PDLC layer has a thickness in a range of 1 um-100 um. The first PDLC layer has the light transmission rate of 50%-80%. The first PDLC layer has refractive index of 1.5-5.5. The composite layer is attached to another composite layer by the first soft resin sheet or the second soft resin sheet with a transparent adhesive layer, wherein the transparent adhesive layer has optical clear adhesive.

In an aspect of the invention, the control device is connected electrically with the composite layer by a flexible print circuit, and the control device comprises: a microprocessor unit, a storage unit, a driving unit and a power supply unit. The microprocessor unit is connected electrically with the wireless receiver unit for receiving the message from the wireless receiver unit. The storage unit is connected electrically with the microprocessor unit for storing the information or the pattern. The driving unit is connected electrically with the microprocessor unit for receiving the message from the microprocessor unit to drive the composite layer. The power supply unit provides electrical power to the control device and the composite layer. The wireless receiver unit comprises the wireless receiver and a decoder connected electrically with the wireless receiver, wherein the wireless receiver receives a wireless signal by infrared protocol, Bluetooth protocol or radio protocol. The wireless emitter unit comprises a plurality of buttons, an encoder connected electrically with the buttons, a wireless emitter connected electrically with the encoder and a power supply connected electrically with the encoder, wherein the wireless emitter emits a wireless signal by infrared protocol, Bluetooth protocol or radio protocol.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a side view of a composite layer used in a wireless controlling polymer dispersed liquid crystal smart window of a first embodiment according to the present invention.

FIG. 2 shows a top view of FIG. 1 from direction of a first soft resin sheet.

FIG. 3 shows a top view of FIG. 1 from direction of a second soft resin sheet.

FIG. 4 shows a side view of two composite layers used in a wireless controlling polymer dispersed liquid crystal smart window of a second embodiment according to the present invention.

FIG. 5 shows a schematic view of a composite layer used in a wireless controlling polymer dispersed liquid crystal smart window of a third embodiment according to the present invention, wherein the composite layer connects with a control device.

FIG. 6 shows a detailed circuit block diagram of FIG. 5.

### DETAILED DESCRIPTION OF THE INVENTION

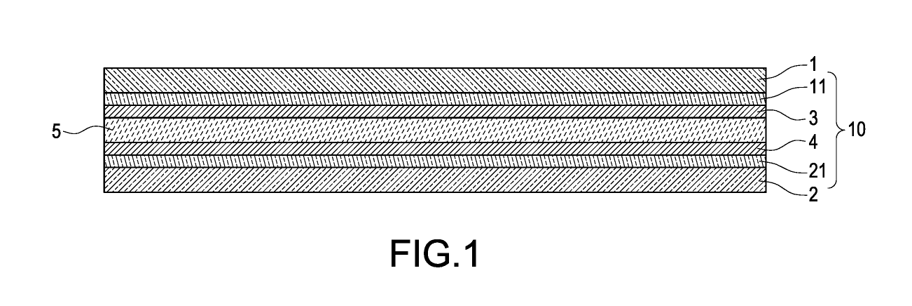

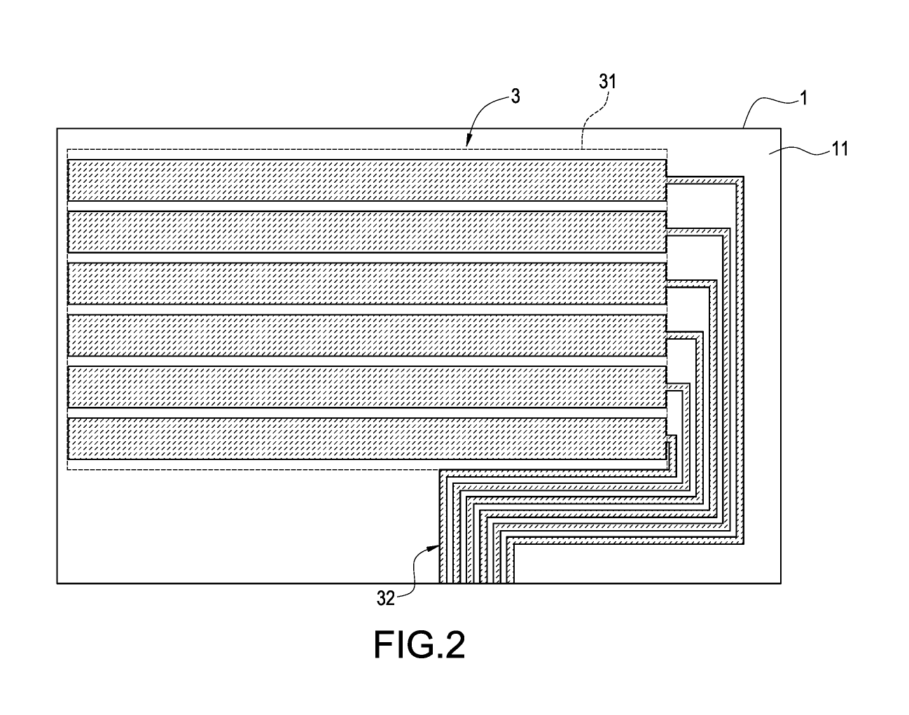

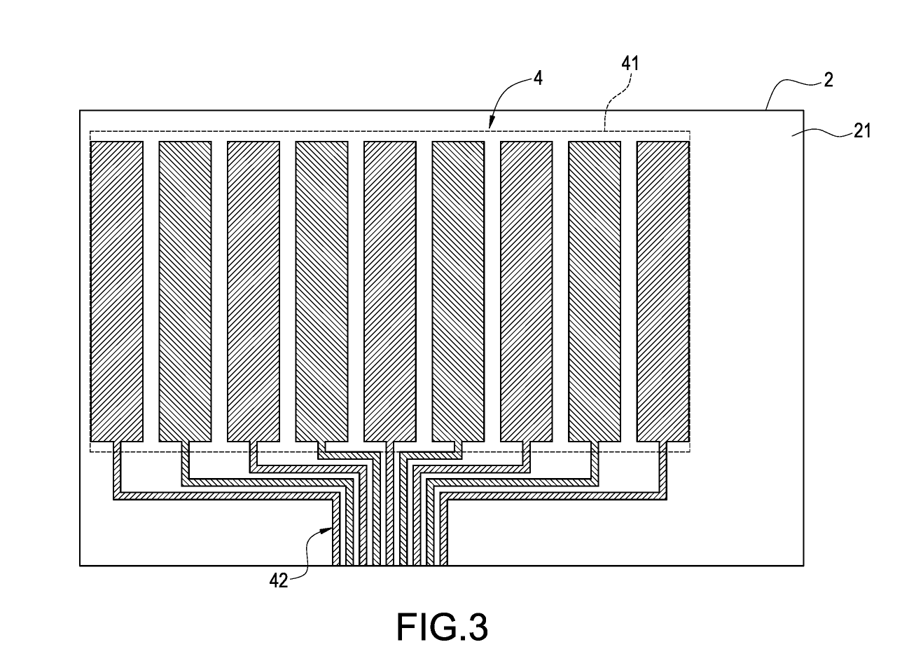

Please refer to FIGS. 1-3. FIG. 1 shows a side view of a composite layer used in a wireless controlling polymer dispersed liquid crystal smart window of a first embodiment according to the present invention. FIG. 2 shows a top view of FIG. 1 from direction of a first soft resin sheet. FIG. 3 shows a top view of FIG. 1 from direction of a second soft resin sheet. In an embodiment, a wireless controlling PDLC smart window comprises at least one composite layer 10 for controlling light transmission of local region. According to FIG. 1, the composite layer 10 comprises a first soft resin sheet 1, a second soft resin sheet 2, a first transparent conductive layer 3, a second transparent conductive layer 4 and a first polymer dispersed liquid crystal (PDLC) layer 5.

The first soft resin sheet 1 and the second soft resin sheet 2 are a material of light transmission resin. The light transmission resin is polyethylene terephthalate (PET), polyethylene (PE), polyimide (PI), polyamide (PA), polyurethanes (PU) or acrylic resin, etc. The first soft resin sheet 1 and the second soft resin sheet 2 have a thickness in a range of 10 um-500 um. Also, a first curing layer 11 is formed on a side surface of the first soft resin sheet 1 by a curing treatment. A second curing layer 21 is formed on a side surface of the second soft resin sheet 2 by a curing treatment. The material used in the first curing layer 11 and the second curing layer 21 is selected from the group consisting of acrylic resin, epoxy and silica. The first curing layer 11 has a thickness in a range of 500 nm-50 um, and preferably, in a range of 1 um-5 um. The second curing layer 21 has a thickness in a range of 500 nm-50 um, and preferably, in a range of 1 um-5 um.

According to FIG. 2, the first transparent conductive layer 3 is provided on a side surface of the first curing layer 11. The first transparent conductive layer 3 comprises a first circuit region 31 and a first cable region 32 which are formed by dry etching or wet etching with inorganic conductive material of metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. The first transparent conductive layer 3 has a thickness in a range of 5 nm-50 um, and preferably, in a range of 100 nm-10 um.

According to FIG. 3, the second transparent conductive layer 4 is provided on a side surface of the second curing layer 21, and corresponded with the first transparent conductive layer 3. The second transparent conductive layer 4 comprises a second circuit region 41 and a second cable region 42 which are formed by dry etching or wet etching with inorganic conductive material of metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. The second transparent conductive layer 4 has a thickness in a range of 5 nm-50 um, and preferably, in a range of 100 nm-10 um.

The PDLC layer 5 is provided between the first transparent conductive layer 3 and the second transparent conductive layer 4. The PDLC layer 5 has a thickness in a range of 1 um-100 um. The PDLC layer 5 is formed of PDLC resins as a main element and mixing with a material selected from the group consisting of UV resins, thermal setting resins and silica, wherein PDLC resins have the light transmission rate of 50%-80% and refractive index of 1.5-5.5 after electric conduction.

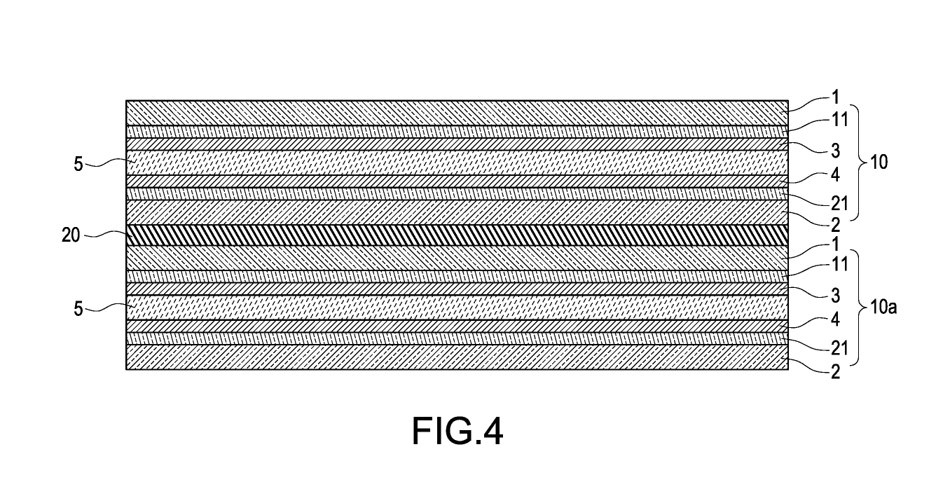

Next, please refer to FIG. 4. FIG. 4 shows a side view of two composite layers used in a wireless controlling polymer dispersed liquid crystal smart window of a second embodiment according to the present invention. The difference between the second embodiment of FIG. 2 and the first embodiment of FIG. 1 is that the composite layer 10 is attached to another composite layer 10a by the first soft resin sheet 1 or the second soft resin sheet 2 with a transparent adhesive layer 20. The composite layer l0a has the same structure to the composite layer 10. In FIG. 4, the transparent adhesive layer 20 has optical clear adhesive (OCA).

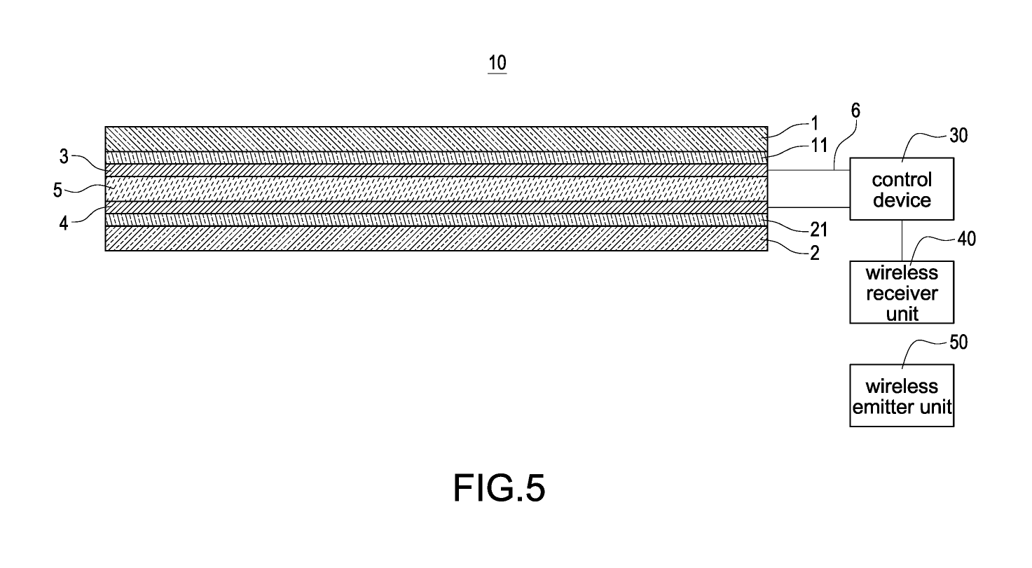

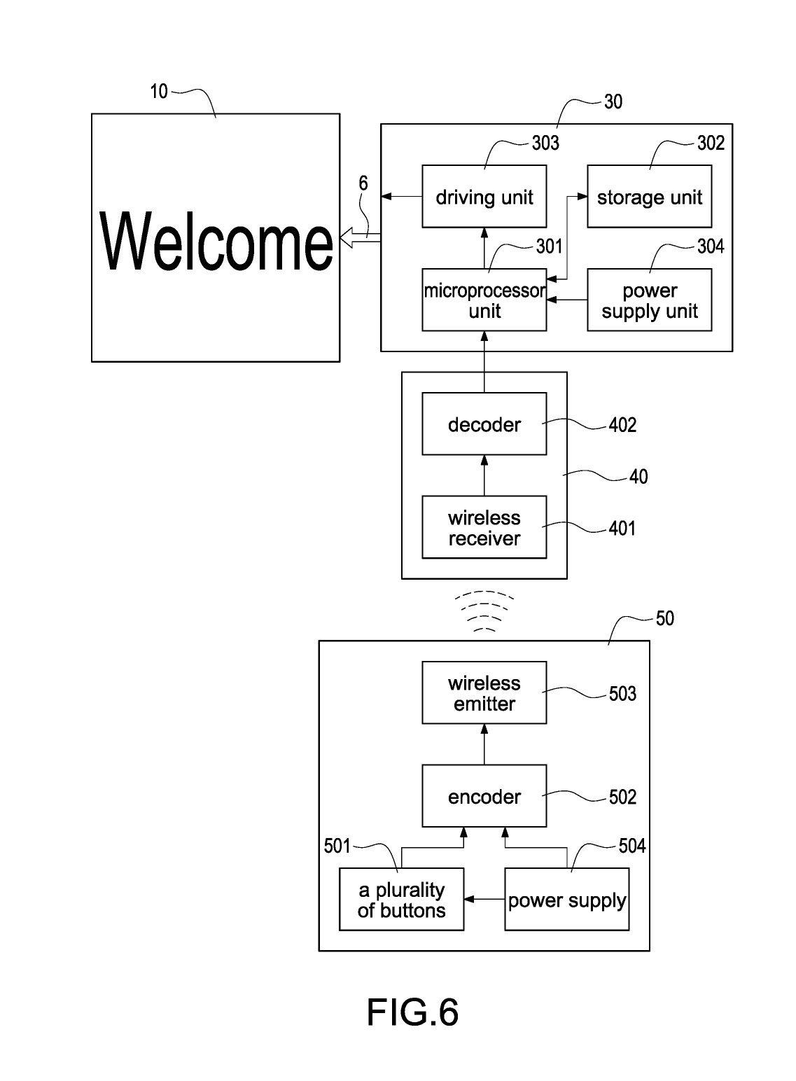

Please refer to FIGS. 5-6. FIG. 5 shows a schematic view of a composite layer used in a wireless controlling polymer dispersed liquid crystal smart window of a third embodiment according to the present invention, wherein the composite layer connects with a control device. FIG. 6 shows a detailed circuit block diagram of FIG. 5. As shown in FIG. 5, the smart window of the embodiment comprises a composite layer 10, a control device 30, a wireless receiver unit 40 and a wireless emitter unit 50.

a flexible print circuit (FPC) 6 is electrically connecting to the first cable region 32 of the first transparent conductive layer 3 at an end and another FPC 6 is electrically connecting to the second cable region 42 of the second transparent conductive layer 4 at an end, and the FPCs 6, 6 are electrically connecting to control device 30 at another end respectively.

The control device 30 comprises a microprocessor unit 301, a storage unit 302, a driving unit 303 and a power supply unit 304. The power supply unit 304 may provide electrical power to the control device 30 and the composite layer 10. The microprocessor unit 301 may process the message from the wireless receiver unit 40. After the massage is processed by the microprocessor unit 301, it is stored in the storage unit 302. As the massage needs to be displayed on the composite layer 10, the microprocessor unit 301 may read the message from the storage unit 302, and the driving unit 303 may drive the composite layer 10 to display the message. In FIG. 6, the storage unit 302 may be memory.

The wireless receiver unit 40 comes with a built-in wireless receiver 401 and a built-in decoder 402 connected electrically with the wireless receiver 401. The built-in decoder 402 may decode the message from the wireless emitter unit 50, and is connected electrically with the microprocessor unit 301 of the control device 30. In FIG. 6, the wireless receiver 401 may receive a wireless signal by wireless transmission protocol, for example infrared protocol, Bluetooth protocol, radio protocol.

The wireless emitter unit 50 comprises a plurality of buttons 501, an encoder 502, a wireless emitter 503 and a power supply 504. The power supply 504 may provide electrical power to the wireless emitter unit 50. After a message of control operation is inputted by the buttons 501 and then encoded by the encoder 502, it is emitted by the wireless emitter 503 to the wireless receiver unit 40. In FIG. 6, the wireless emitter unit 50, for example a remote controller may emit a wireless signal by wireless transmission protocol, for example infrared protocol, Bluetooth protocol, radio protocol.

With the use of a wireless controlling polymer dispersed liquid crystal smart window of a third embodiment according to the present invention, after a message of “welcome” is inputted by the buttons 501 of the wireless emitter unit 50, the message is emitted by the wireless emitter unit 50 to the wireless receiver unit 40. Next, the message is transmitted by the wireless receiver unit 40 to the control device 30. After the message is processed by the microprocessor unit 301, it is stored in the storage unit 302, and at the same time the driving unit 303 may drive PDLC layer 5 by the first transparent conductive layer 3 and the second transparent conductive layer 4 of the composite layer 10 to display the message of “welcome”.

Alternatively, after an instruction is inputted by the wireless emitter unit 50 and the instruction is emitted by the wireless emitter unit 50 to the wireless receiver unit 40, the instruction is transmitted by the wireless receiver unit 40 to the control device 30. After the instruction is received by the microprocessor unit 301, the microprocessor unit 301 reads from the storage unit 302 a message which is stored in the storage unit 302 previously, and the driving unit 303 may drive PDLC layer 5 by the first transparent conductive layer 3 and the second transparent conductive layer 4 of the composite layer 10 to display the built-in message, for example information or pattern.

The invention can achieve the advantages including strengthening of glass, heat insulation of glass and message display. The composite layer of the invention can combine with a variety of objects and devices to produce excellent effect. The invention is not limited to these embodiments, but various variations and modifications may be made without departing from the scope of the invention.

What is claimed is:

1. A wireless controlling polymer dispersed liquid crystal smart window, comprising:
at least one composite layer;
a control device, connected electrically with the composite layer;
a wireless receiver unit, connected electrically with the control device; and
a wireless emitter unit, coupled to the wireless receiver unit,
wherein, the wireless emitter unit emits a message of control operation to the wireless receiver unit, the message is transmitted from the wireless receiver unit to the control device, and the control device drives the composite layer to display information or pattern after the massage is processed.

2. The wireless controlling polymer dispersed liquid crystal smart window according to claim 1, wherein the composite layer comprises:
a first soft resin sheet, having a first curing layer on a side surface of the first soft resin sheet;
a first transparent conductive layer, provided on a side surface of the first curing layer, and electrically connected with the control device, the first transparent conductive layer comprising a first circuit region and a first cable region;
a second soft resin sheet, having a second curing layer on a side surface of the second soft resin sheet;
a second transparent conductive layer, provided on a side surface of the second curing layer, and electrically connected with the control device, the second transparent conductive layer comprising a second circuit region and a second cable region; and
a first polymer dispersed liquid crystal (PDLC) layer, provided between the first transparent conductive layer and the second transparent conductive layer.

3. The wireless controlling polymer dispersed liquid crystal smart window according to claim 2, wherein the first soft resin sheet and the second soft resin sheet are a material of light transmission resin.

4. The wireless controlling polymer dispersed liquid crystal smart window according to claim 3, wherein the light transmission resin is polyethylene terephthalate (PET), polyethylene (PE), polyimide (PI), polyamide (PA), polyurethanes (PU) or acrylic resin.

5. The wireless controlling polymer dispersed liquid crystal smart window according to claim 2, wherein the first soft resin sheet has a thickness in a range of 10 um-500 um and the second soft resin sheet has a thickness in a range of 10 um-500 um.

6. The wireless controlling polymer dispersed liquid crystal smart window according to claim 2, wherein the first curing layer or the second curing layer is a material selected from the group consisting of acrylic resin, epoxy and silica.

7. The wireless controlling polymer dispersed liquid crystal smart window according to claim 2, wherein the first curing layer or the second curing layer has a thickness in a range of 1 um-5 um.

8. The wireless controlling polymer dispersed liquid crystal smart window according to claim 2, wherein the first transparent conductive layer and the second transparent conductive layer are made of an inorganic conductive material or an organic conductive material.

9. The wireless controlling polymer dispersed liquid crystal smart window according to claim 8, wherein the inorganic conductive material is a material of metal or metallic oxide.

10. The wireless controlling polymer dispersed liquid crystal smart window according to claim 8, wherein the organic conductive material is a conductive material mixing with carbon nanotube or poly-3,4-ethylenedioxythiophene.

11. The wireless controlling polymer dispersed liquid crystal smart window according to claim 2, wherein the first transparent conductive layer or the second transparent conductive layer has a thickness in a range of 5 nm-50 um.

12. The wireless controlling polymer dispersed liquid crystal smart window according to claim 11, wherein the first transparent conductive layer or the second transparent conductive layer has a thickness in a range of 100 nm-10 um.

13. The wireless controlling polymer dispersed liquid crystal smart window according to claim 2, wherein the first transparent conductive layer or the second transparent conductive layer has the light transmission rate of 70%-95%.

14. The wireless controlling polymer dispersed liquid crystal smart window according to claim 2, wherein the first PDLC layer is formed of PDLC resins as a main element and mixing with a material selected from the group consisting of UV resins, thermal setting resins and silica.

15. The wireless controlling polymer dispersed liquid crystal smart window according to claim 2, wherein the first PDLC layer has a thickness in a range of 1 um-100 um.

16. The wireless controlling polymer dispersed liquid crystal smart window according to claim 2, wherein the first PDLC layer has the light transmission rate of 50%-80%.

17. The wireless controlling polymer dispersed liquid crystal smart window according to claim 2, wherein the first PDLC layer has refractive index of 1.5-5.5.

18. The wireless controlling polymer dispersed liquid crystal smart window according to claim 2, wherein the composite layer is attached to another composite layer by the first soft resin sheet or the second soft resin sheet with a transparent adhesive layer.

19. The wireless controlling polymer dispersed liquid crystal smart window according to claim 18, wherein the transparent adhesive layer has optical clear adhesive.

20. The wireless controlling polymer dispersed liquid crystal smart window according to claim 2, wherein the control device is connected electrically with the composite layer by a flexible print circuit, and the control device comprises:
a microprocessor unit, connected electrically with the wireless receiver unit for receiving the message from the wireless receiver unit;
a storage unit, connected electrically with the microprocessor unit for storing the information or the pattern;
a driving unit, connected electrically with the microprocessor unit for receiving the message from the microprocessor unit to drive the composite layer; and
a power supply unit, providing electrical power to the control device and the composite layer.

21. The wireless controlling polymer dispersed liquid crystal smart window according to claim 2, wherein the wireless receiver unit comprises the wireless receiver and a decoder connected electrically with the wireless receiver.

22. The wireless controlling polymer dispersed liquid crystal smart window according to claim 21, wherein the wireless receiver receives a wireless signal by infrared protocol, Bluetooth protocol or radio protocol.

23. The wireless controlling polymer dispersed liquid crystal smart window according to claim 2, wherein the wireless emitter unit comprises a plurality of buttons, an encoder connected electrically with the buttons, a wireless emitter connected electrically with the encoder and a power supply connected electrically with the encoder.

24. The wireless controlling polymer dispersed liquid crystal smart window according to claim 23, wherein the wireless emitter emits a wireless signal by infrared protocol, Bluetooth protocol or radio protocol.
